(19) United States
(12) Patent Application Publication
(10) Pub. No.: US 2022/0048066 A1
(43) Pub. Date: Feb. 17, 2022

(54) METHOD OF COATING AN EYEGLASS LENS

(71) Applicant: SHAPE ENGINEERING GMBH, Köln (DE)

(72) Inventors: Joerg LUDERICH, Ratingen (DE); Christian POEPPERL, Solingen (DE); Michael KREIS, Gruendau (DE); Christian TUSS, Wetzlar Hessen (DE); Herger ALT, Lahnau Hessen (DE)

(21) Appl. No.: 17/274,804

(22) PCT Filed: Oct. 22, 2019
(86) PCT No.: PCT/EP2019/078742

§ 371 Date: Apr. 29, 2021

(30) Foreign Application Priority Data
Nov. 14, 2018 (DE) 10 2018 008 957.7

(51) Int. Cl. B05D 1/26; G05B 19/4093

(52) U.S. Cl. CPC B05D 1/26; G05B 2219/49066; G05B 19/40931

(57) ABSTRACT

The invention relates to a method for coating eyeglass lenses, in particular for coating the edge of eyeglass lenses by means of a needle metering device or jet metering device, wherein the eyeglass lens and the metering device are moved relative to one another and at the same time a coating material is applied to the eyeglass lens, in particular to the edge thereof, from the metering device. The control data for controlling the movement of the eyeglass lens and/or of the metering device are determined before and/or during the application process on the basis of geometric data of the metering device and geometry data of the eyeglass lens surface to be coated, said geometry data of the eyeglass lens surface to be coated being measured or being drawn from a data store.

The invention relates to a method of coating an eyeglass lens, in particular for coating the edge of an eyeglass lens by a needle or jet applicator, where the eyeglass lens and the applicator are moved relative to each other and a coating material is projected by the applicator onto the eyeglass lens, in particular the edge.

A needle applicator is understood to be a device whose tubular needle continuously projects a stream of coating material onto a surface to be coated. A jet applicator is understood to be a device that projects the coating material as drops from the dosing head toward the surface to be coated. The ejected drops follow a trajectory from the dosing head to the surface to be coated.

The edge coating of an eyeglass lens with a liquid, as described in DE 10 2018 002 384.3 [US 2021/0011308] (registration of function-optimized layers), is subject to a multitude of factors that influence the coating. In addition to the forces acting on the coating material, lens shape and thickness vary from lens to lens. As described in DE 10 2018 002 384.3, it makes sense to coat the geometrically variable edge surface of the eyeglass lens by controlling the amount of the coating material as a function of the edge thickness. Also axial displacement of the coating position is a function of the thickness profile provided here in order to achieve uniform coating. Such control of the amount of coating material and/or the positioning of the applicator can also be used in the invention further described below.

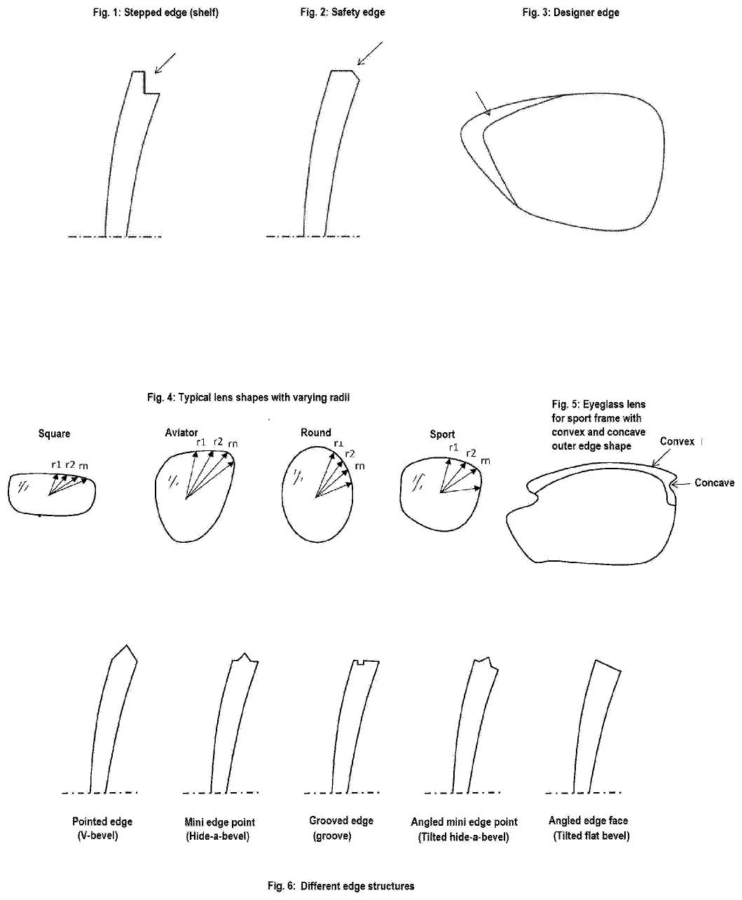

In this procedure, on largely ignores the relationships between position and orientation, in particular the angular orientation of the applicator and the position and orientation, especially the angular orientation of the surface of the eyeglass lens edge to be coated, in space (the earth reference system) or relative to each other, as well as furthermore the type and arrangement of the axes of movement necessary for the coating as well as the control of the relative position and relative movement between the applicator and the edge surface. As an edge in the context of this patent application is also understood to include areas of a eyeglass lens that are manufactured during the edge processing of the eyeglass lens to prevent damage from the glasses frame (for example shelf “for sports glasses, FIG. 1), to reduce the risk of injury (for example safety bevels, FIG. 2) or for aesthetic reasons of attachment (for example decorative facet, FIG. 3).

Depending on the design of the eyeglass frame, an eyeglass lens can be manufactured in very different shapes From round about almost any shape can be used from aviator to rectangular shapes, FIG. 4. The curvature of the edge therefore varies as a function of the circumferential angular position (when rotating the lens about its optical axis or parallel to it) for each individual glass, as also from lens to lens. The shapes are for example defined as radii at uniform angular offsets. A specific curvature results as a function of the radius the “outer shape, FIG. 4.

The curvature of the edge is convex on most glass shapes, but can also be concave, for example for an eyeglass lens for a sports frame, FIG. 5.

Furthermore, the outer peripheral edge of an eyeglass lens are shaped to ensure that the lens is well secured and centered in the frame. Hence, different edge structures are manufactured, some of the main ones of which are shown in FIG. 6.

The outer surfaces of a eyeglass lens are therefore made up of several shapes that are very different and fundamentally different for every lens. Coatings of the lens edge are, for example, cover the entire eyeglass lens edge or only selected edge areas, in partial areas of the eyeglass lens edge. Other areas, in particular the optically effective surfaces, on the other hand, should preferably not or can only be coated in exceptional cases.

These problems arise with coating methods of different geometries of the edge problems that are specific to the task at hand.

Basically, high quality coating results are best achieved when the geometric relationships between applicator and surface to be coated during the coating method remain constant. In practice, however, it can turn out to be not feasible to provide an ideal relative location between a eyeglass lens and an applicator during the whole continuous coating method, or this ideal relative situation would only be done at uneconomically high control or machine effort. For example this could only be achieved with machines that have a high number of degrees of freedom in movement of the lens and/or applicator. Such machines are however, expensive.

Of particular importance are the spacing and angle between applicator and surface to be coated, in particular the edge surface of the eyeglass lens. For coatings with an applicator needle, the spacing is preferably smaller than that inner diameter di of the applicator needle, preferably di/2. This is advantageous as it creates a stable liquid bridge to the surface to be coated. In the case of jet applicators, the preferably range is approximately 1-2 mm, and the tip of the jet applicator is significantly larger due to the way it works than with that of an applicator needle. Usual widths of the dosing head of jet applicators is in the range b=5 to 20 mm and are therefore up to 20 times larger than for the needle applicator.

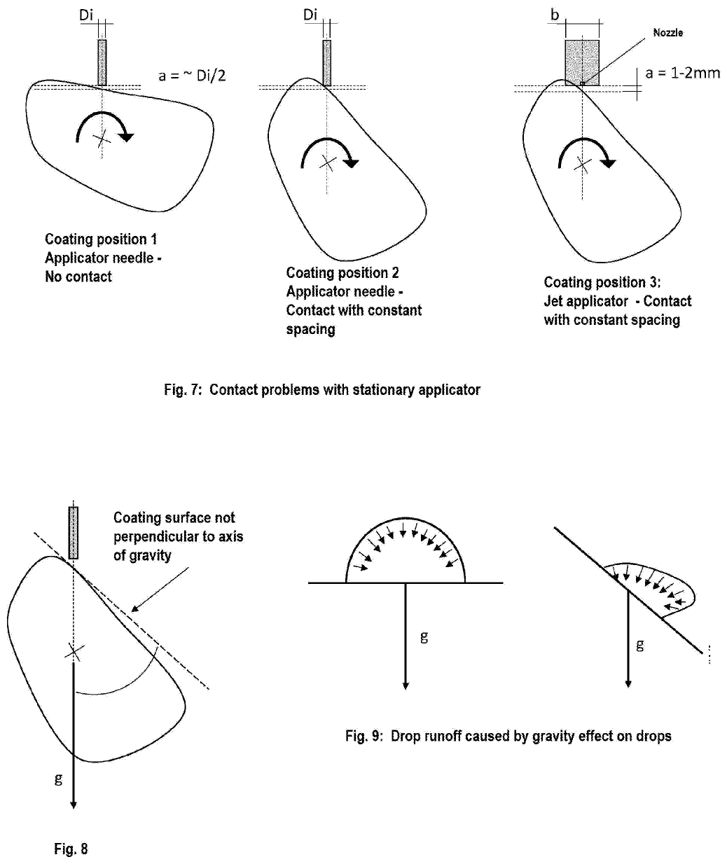

FIG. 7 shows the resulting problems for fixed applicators. As can be seen, when rotating an eyeglass lens the edge of the lens can come into contact with the applicator. Furthermore, the gap geometry below the applicator needle or the angle of incidence with a jet applicator varies. This changes the flow behavior or the drop shape on the edge of the lens.

Another important problem is caused by gravity acting on the coating liquid if the coating surface is not perpendicular to the axis of gravity, that is not oriented horizontally, FIG. 8. Depending on the amount of tilt, the desired layer thickness, and the viscosity and density of the coating material this leads to uneven layer thicknesses up to undesired run-off of the coating material. The underlying problem is, for example, influencing the balance of forces between the coating material and the surface through the influence of the acting gravity taking into account the tilting of the coating surface, FIG. 9.

It is therefore an object of the invention to provide a method of coating of a eyeglass lens, in particular the edge of an eyeglass lens with which on economically justifiable, especially inexpensive, coating is produced while avoiding the problems described.

According to the invention, this object is attained by a method of above-described type in which the control data for controlling movement of the lens and/or the applicator before and/or during the application method is based on geometrical data of the applicator and geometrical data measured or taken from a data memory relating to the surface to be coated, in particular the edge surface of the eyeglass lens. For example, such data can be stored in the controller.

Preferably, the invention provides that all of the data required for movement of the eyeglass lens and/or the applicator when coating is determined before implementation the coating operation and in particular these data from the controller are retrieved from the controller and applied to actuators that move the lens and/or the applicator retrieved for movement according to this predetermined control data. In this case the preferred the movements of the eyeglass lens and/or applicator are completely determined before coating.

The control data is preferably determined in such a way that during the entire coating method a predetermined relative position, preferably an ideal one relative position between eyeglass lens and applicator is adhered to. In this way this relative position is ideally used during the entire coating process.

When determining the control data for maintaining a predetermined relative position, in particular one desired ideal relative position, it can turn out that this predetermined relative position is not usable for the whole coating method, for example not at every circumferential angular position when rotating the eyeglass lens, or in other words, it may be the case that under the above-described requirements the control data is not completely determined for the whole coating method. This can for example occur when determining the control data shows that there is at least one point when the lens and/or applicator contact each other or another predetermined method condition is not usable.

The invention can provide that in such a case a change of the predetermined/given relative position is prompted or a change to the predetermined position is made automatically by the control system. The change can for example be that a new predetermined relative position that deviates from the previous one, especially an ideal one, for example due to a difference. After that, the control data is determined.

The method of changing the predetermined relative position can be done several times, for example iteratively, until the control data is determined for the entire coating method, for example for all circumferential angular positions when the lens is rotated.

In this case, the determination of the control data converges to a predetermined relative position, for example with one of the positions assumed to be ideal. This is nevertheless advantageous because in this case the predetermined position is maintained during the entire coating method relative position, even if this it is not the ideal position.

During the iteration it can also be provided that the difference with which a new predetermined relative position is formed on the basis of a previous relative position, is changed, for example reduced.

The invention can also provide only for positions in which the predetermined relative position cannot be maintained, to change this predetermined relative position, in particular as long, if necessary, also iteratively, until the corresponding position is reached (possibly several times). This way the coating method with the determined control data can be fully executed, and there are positions on the trajectory of the lens and/or are applicators, at which the relative position according to original, especially ideal, model is met as well as positions where the relative position deviates from it.

The invention can also provide the control data initially or calculate it in advance so long as the given relative positions adhere to and the trajectory of the lens and/or applicator on which these predetermined relative position not reached in the pre-calculation of the control data while the coating is being carried out to so control the relative position at least within predetermined limits while the coating is being carried out. For this purpose, the invention can provide detection of the relative position during the coating by measurement.

In all embodiments, the invention can provide that, with control data determined before and/or during the coating and during movement of the eyeglass lens and/or the applicator, the relative position between the to lens surface to be coated and the applicator is adhered to within predetermined limits.

The predetermined limits can be, for example, set as an angular range be given within which the relative position is maintained.

In one possible embodiment, the invention can provide that the eyeglass lens is rotated and the rotation-induced angular positions can be determined from the stored geometric data that determine the control data that are required to move the applicator so that the predetermined relative position between the surface to be coated and the applicator is achieved in all coating positions.

Also, for example with a fixed applicator, especially when the application axis is aligned parallel to the direction of gravity, the lens can be rotated and, depending on the angle of the rotation position derived from the stored geometric data, the control data required for alignment of the axis of rotation and/or the spacing between the surface and the applicator are determined so as to change that the predetermined relative position between the surface to be coated and the applicator in all coating positions.

A preferred rotation of the eyeglass lens during the coating method is according to the invention about the optical axis of the lens or around an axis of rotation parallel to the optical axis of the lens.

In order to maintain the predetermined relative position, in particular, if necessary, iteratively, for example the position of the axis of rotation, preferably fixed relative to the eyeglass lens is changed in three dimensions for example by changing the angle and/or straight-line displacement of the axis of rotation. At least one machine degree of freedom used for this is provided in the machine with which the coating is carried out.

Instead of the possibilities of movement specifically mentioned here also other movements of the eyeglass lens and/or applicator can be executed.

Depending on the applicator used, preferably at least the following geometric data for the determination of the control data is used, for example in the control data saved or entered for motion control.

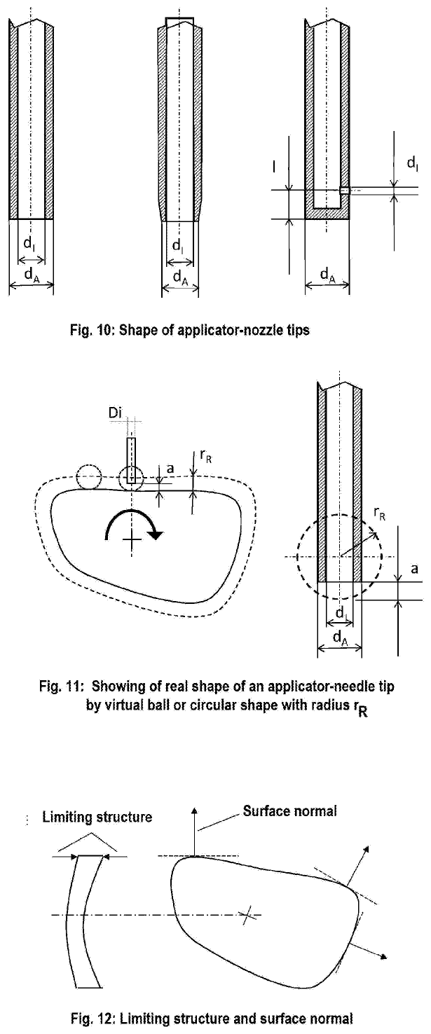

In the case of applicator needles, for example, the direct or indirect description of the relevant geometry for the application method needle point, in particular the position and orientation of the dosing needle tip relative to the machine coordinate system must be taken into account. In FIG. 10 three embodiments of applicator needles are shown.

For example, the position and orientation of the material outlet relevant to the coating process can be stored, especially with respect to contact with the edge of the lens, also preferably the outside diameter da of the needles. Corresponding data can also can be entered indirectly into the control by the shape of the real applicator needle through a suitable virtual geometry, for example a spherical or circular geometry with the radius r_{R} is described, FIG. 11.

In the case of jet applicators, the position and orientation of the nozzles, especially those for contact with the geometry parameters relevant to the edge of the glass, for example the width b of the dosing head stored in the controller. Corresponding data can also be entered indirectly into the controller with respect to the real geometry through a suitable virtual geometry, for example a spherical or circular geometry with the radius r_{R}.

The geometry of the surfaces to be coated is defined by the limiting structures, in particular those spaced in the direction of the optical axis of the eyeglass lens front and rear faces at the lens rim, and/or relative to the surface normal at each application position. The vectorial position of the surface normals changes in dependence on the considered position within the area, FIG. 12. It can thus be provided for a eyeglass lens, one large number of data for the surface normals at each to save the order position.

Controlling movement of the lens relative to the applicator and/or of the applicator relative to lens takes place in a further preferred manner so that the determined control data maintains a predetermined relative position of application axis of the applicator in an angular range of less than or equal to ±45° around the normal to the surface of the one surface to be coated, preferably less than or equal to ±15° around the surface normal to the surface to be coated.

Maintenance of the relative position between the applicator the surface to be coated within these limits is sufficient for coating.

With the above-described change in the relative position, in particular with one iteration, the invention can provide for automatically changing the relative position within these limits.

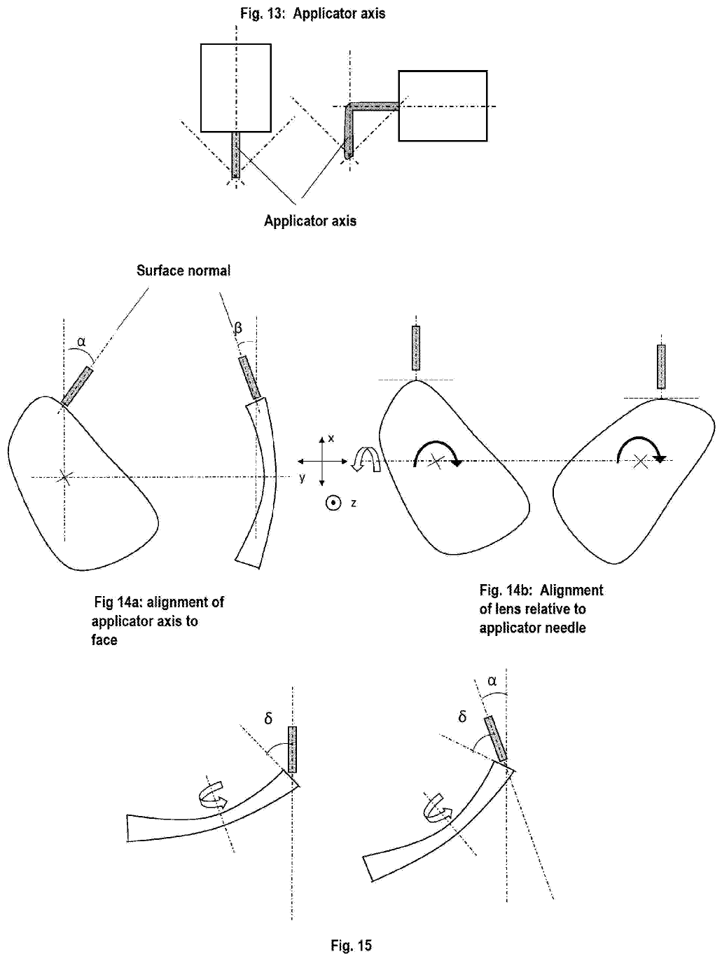

The axis of an applicator is understood to be the axis of the applicator needle just before the coating liquid emerges. In the case of a curved applicator needle, it is defined as the end part of the needle is the application axis, FIG. 13. In particular, the axis is the direction along which the coating material emerges from the applicator needle undisturbed. The application axis of an applicator needle is therefore located according to the invention in a cone with an opening angle of at most ±45° relative to the surface normal.

In the case of a jet applicator, the dispensing axis is the path followed by the ejected drops. According to the above description it is also in this case that the application axis lies in a cone with an apex angle of ±45°, preferably less than ±15° relative to the surface normal.

Depending on the position of the surface to be coated, the required relative position of the lens surface and the application axis for the above angular range according to the invention, for example movements is effected by movement about up to two axes of rotation (angles α and β,) FIG. 14a. Alternatively, the relative movement can be achieved by a combination of three translatory and two rotary movements.

In particular, in all possible embodiments of the control movement of the eyeglass lens and/or the application axis is translational and/or rotational, FIG. 14b.

In a further embodiment of the invention, it is preferably provided that the axis of the applicator extends in an angular range of ±45° to the axis defined by gravitational force (in particular the vertical), preferably in the angle range of ±30°. As a result, gravity acts more advantageously way on the airborne liquid. The application axis can be fixed in space or movable, in particular in alignment with the control data within this angular range. This arrangement ensures that the gravitational force essentially, in particular predominantly, acts in the direction of application and there is no significant transverse or counter force on the fluid stream or the liquid droplets.

When using applicator needles, maintenance of a stable liquid stream between the applicator needle and the surface is very important for the quality of the coating. Interruption of the liquid stream or changes to its shape significantly during the application method create flaws or unevenness in the coating. This issue occurs in particular when the relative angular position between the surface and application axis are not constant during application or the tracking of the angular position is not continuous, but in steps.

Despite a changing angular position between the application axis and the lens surface, a stable liquid bridge can be achieved in that the invention preferably provides that the shape of the applicator needle is circular or spherical with a radius r_{R} whose the center lies at least approximately, preferably precisely on the application axis, FIG. 11. Movements during the coating method are then controlled so that the edge surface of the lens edge always touches this circle or spherical shape, in particular tangentially contacts the circle or sphere. The circular or preferred ball geometry is virtually positioned on the application axis so that in the event that the application axis is normal/perpendicular to the edge surface it is between the applicator needle and the surface of the spacing a is determined as a function of the inner diameter di of the dosing needle in the range 0.25×di to 1.25×di, preferably in the range 0.4×di up to 0.6×di.

More preferred for the coating of eyeglass lens edges in the relevant angular range, for forming between the application axis and the surface a stable and sufficiently constant liquid bridges, a radius r_{R} is chosen so that it lies between the sizes r1 and r2. There the radii r1 and r2 are determined as follows:

r1≥3/4*di,preferably≥5/4*di

and

r2≥1.5*(2*di²+2*da*di+da²)/(4*di) preferably≥(2*di²+2*da*di+da²)/(4*di)

To further increase the stability of the liquid bridge with changing angular positions between the application axis and the lens surface, in a further embodiment according to the invention to position the lens relative to the angle range of ±45° of the axis defined by the fixed axis of gravity of the applicator so that the angle d between surface to be coated and axis of the applicator lies in the range from 15 to 60°, preferably in the range of 30 to 45°, FIG. 15. This version can be used as an alternative to the above-described execution are carried out, according to the an angular range around the area normal is adhered to.

This embodiment of the invention is particularly suitable for needle applicator systems and reduces the risk of contact (needle/lens) under largely constant conditions for the liquid bridge between the surface and the applicator needle.

1. A method for coating the edge of an eyeglass lens by a needle or jet applicator, the method comprising the steps of: that are moved
moving the lens and the applicator relative to each other while projecting from the applicator a coating material on the edge of eyeglass lens;
determining control data based on geometric data of the applicator and edge to be coated either taken from a data memory or derived from measurement; and
controlling relative movement of the lens and applicator using the control data.

2. The method according to claim 1, wherein the control data is determined for a predetermined relative position of eyeglass lens and applicator by changing the relative position until sufficient control data are available for the entire coating method when the predetermined relative position is maintained.

3. The method according to one of the preceding claims, claim 1, further comprising the step of, during movement of the eyeglass lens and/or of the applicator,
maintaining the relative position between the lens surface to be coated and the applicator within predetermined limits.

4. The method according to claim 1, further comprising the step, when using an applicator needle, of
using a direct or indirect model to determine the shape of the needle tip or the position and orientation of the applicator needle tip relative to the machine coordinate system.

5. The method according to claim 1, further comprising the step, when using a jet applicator, of:
using a direct or indirect model of the relevant shape of the jet applicator and the flight direction of the drops and/or the position and orientation of the dosing nozzle relative to the machine coordinate system.

6. The method according to claim 1, further comprising the step of:
determining the shape of the surface to be coated at every position of the surface to be coated relative to a surface normal.

7. The method according to claim 1, further comprising the step of:
using the determined control data to maintain the relative position of an application axis of the applicator in an angular range of less than or equal to ±45° relative to the surface normal of the surface to be coated.

8. The method according to claim 1, further comprising the step of:
fixing or determining by the control data an application axis of the applicator within an angular range of less than or equal to ±45° around a direction of gravity.

9. The method according to claim 1, further comprising the step when using the applicator needle of:
using the control data to maintain a spacing (a) between the applicator needle and the surface to be coated in the range 0.25×di to 1.25×di where di is an inner diameter of the applicator needle.

10. The method according to claim 1, further comprising the step of:
establishing an indirect model of the shape of a square- or angle-ended applicator needle of a circular or spherical shape with a radius r_{R} employed for control, the radius r_{R} being chosen so that it lies between dimensions r1 and r2, where r1 and r2 are calculated as follows:
r1=3/4*di and
r2=1.5*(2*di²+2*da*di+da²)/(4*di)
where d1 is an inside radius of the needle and da is an outside radius thereof.

11. The method according to claim 1, further comprising the step of:
fixing an application axis in an angular range of ±45° relative to the axis course of the force of gravity and the angle (d) between surface to be coated and the axis of the applicator in the range of 15 to 60°.
